(19) United States
(12) Patent Application Publication
(10) Pub. No.: US 2013/0056399 A1
(43) Pub. Date: Mar. 7, 2013

(54) Storm water filtration Device

(71) Applicant: Richard Tab Downare, Fort Myers, FL (US)

(72) Inventor: Richard Tab Downare, Fort Myers, FL (US)

(21) Appl. No.: 13/374,792

(22) Filed: Jan. 13, 2012

Related U.S. Application Data
(60) Provisional application No. 61/573,804, filed on Sep. 7, 2011.
(60) Provisional application No. 61/573,805, filed on Sep. 7, 2011.
(60) Provisional application No. 61/573,806, filed on Sep. 7, 2011.

(51) Int. Cl. C02F 1/00; B23P 17/04

(52) U.S. Cl. 210/170.03; 29/428

(57) ABSTRACT

A storm water filtration device for removing storm water contaminants includes a pocket portion, an engagement element(s), and an overflow port(s). As the pocket portion fills with storm water, contaminants having a specific gravity greater than 1.0 are collected within the pocket portion, while storm water continues flowing through the drain via the overflow port(s). Optionally, the pocket portion can include an inner liner disposed within the pocket portion. The liner can be formed of a porous material that can capture and retain liquid and/or solid contaminants carried by the storm water.

### RELATED DOCUMENTS

This disclosure is related to, incorporates by reference in their entireties, and claims the priority benefits of the following US Provisional patent applications: Ser. No. 61/573,804 entitled “Transformer Oil Bag,” Ser. No. 61/573,805 entitled “Basin Blocker Grate,” and Ser. No. 61/573,806 entitled “Basin Blocker Curb,” all of which were filed on Sep. 7, 2011 by Richard Tab Downare.

### BACKGROUND OF THE INVENTION

Storm water management systems can utilize storm water drains to divert storm water by collecting the storm water at one or more points and carrying the storm water below the surface and providing the same to storm water depositories, such as retention ponds, creeks, natural ponds, lakes, oceans, seas, tributaries, etc. Storm water can carry myriad pollutants.

### SUMMARY OF THE INVENTION

It is, therefore, an object of the present invention to provide a storm water filtration device.

In an exemplary embodiment of the present invention, a storm water filtration device is adapted to remove contaminants carried by storm water entering a storm drain, with the device comprising the following:

a pocket portion, being formed of an at least substantially impermeable material, and having a volume capacity; at least one engagement element extending from the pocket portion, and being adapted to securely engage the storm drain so as to fixably position the pocket portion within the storm drain; and at least one overflow port, defined at least in part by the material.

When the at least one engagement element is engaged with the storm drain, the pocket portion is positioned to receive at least a portion of the storm water entering the storm drain; and at least a portion of the contaminants, carried by the storm water, and having a specific gravity greater than 1.0, are collected within the pocket portion, while the at least one overflow port allows the received storm water to continue flowing through the drain as the received storm water exceeds the volume capacity of the pocket portion.

In an exemplary aspect of the present invention, the pocket part can include an optional inner liner disposed within the pocket part, and can be formed of a porous material adapted to capture and retain at least a portion of one of a liquid contaminant and a solid contaminant carried by the storm water.

In another exemplary aspect of the present invention, the at least one engagement element can include one or more extension elements, each with one or more respective abutment elements. An abutment element can have an overall size greater than an opening of the storm drain along one or more axes of the opening, and the one or more extension elements can be adapted to extend through the opening while the respective abutment elements abut at least one portion of the drain, so as to securely engage the storm drain. Notably, an abutment element can be integral with an extension element or attached thereto.

In yet another exemplary aspect of the present invention, an engagement element can include both, an abutment element having an input aperture and an exhaust flange, and an intake sleeve adapted to connect to, and receive storm water from, the exhaust flange; the abutment element can have an overall size greater than an opening of the drain along at least one axis of the opening; and the abutment element can be adapted, to abut a portion of the storm drain so as to securely engage the storm drain, to receive via the input aperture at least a portion of the storm water, and to direct the at least a portion of the storm water through the exhaust flange.

In still a further exemplary aspect of the present invention, an engagement element can optionally include one or more lifting elements, such as a handle, knob, hand hold, or a loop, for example and not in limitation.

In still another exemplary aspect of the present invention, an engagement element can include one or more extension elements adapted to engage the storm drain by being respectively held between an exterior portion of the storm drain and a storm grate or cover engaged with an opening of the storm drain.

In additional exemplary aspects of the present invention, methods of installing and performing maintenance on a storm water filtration device are disclosed herein.

These and other exemplary aspects of the present invention are described herein.

### BRIEF DESCRIPTION OF THE DRAWINGS

The present invention is illustrated by way of example, and not in limitation, in the figures of the accompanying drawings, in which:

FIG. 1 illustrates an exemplary embodiment of the present invention, in which a storm water filtration device 100 can include a pocket portion 110, at least one engagement element 120, at least one overflow port 130, and an optional inner liner 140.

FIG. 2 illustrates an exploded view of an exemplary environment of the present invention, in which storm water filtration device 200 can be utilized with a storm drain 250 having a storm grate 252.

FIG. 3 illustrates an exemplary application of an exemplary storm water filtration device 300, in which an engagement element 320 can be adapted to engage storm drain 350 by being held between a portion 354 of the storm drain and a storm grate 354.

FIG. 4 illustrates an exemplary aspect of the present invention in which engagement element 420 can comprise an extension element 422 having an abutment element 424.

FIG. 5 illustrates an exemplary application of an exemplary storm water filtration device 500, in which an abutment element 524 can abut a portion 554 of the storm drain 550 so as to securely engage the drain.

FIG. 6 illustrates the exemplary storm water filtration device 600 of FIG. 5, but optionally with an engagement element 620 engaged with drain 650 via a grate or cover 656.

FIG. 7 illustrates another exemplary aspect of the present invention in which an engagement element 720 can comprise, an abutment element 724 having an input aperture 727 and an exhaust flange 728, and an intake sleeve 729 connected to the exhaust flange.

FIG. 8 illustrates an exemplary application of exemplary device 800 in FIG. 7, in which abutment element 824 abuts a portion 254 of storm drain 850 with aperture 827 aligned with an opening 258 of drain 850, such that storm water (not shown) is directed through the exhaust flange 828 and intake sleeve 829.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, material, or order.

In a basic exemplary embodiment of the present invention, a storm water filtration device can remove contaminants carried by storm water entering a storm drain, and can include the following: a pocket portion; at least one engagement element; and at least one overflow port. A pocket portion can be formed of a substantially impermeable material, and can have a volume capacity; an engagement element can extend from the pocket portion, and can be adapted to securely engage (directly or indirectly) any portion of the storm drain, which fixably positions the storm water filtration device within the storm drain; and an overflow port can be defined at least in part by the material.

In operation, when the at least one engagement element is engaged with the storm drain, the pocket portion is positioned to receive at least a portion of the storm water entering the storm drain. For example and not in limitation, the at least a portion of storm water flows into the pocket portion directly from a storm drain opening or via a storm water pipe. The storm water fills the pocket portion and storm water contaminants having a specific gravity greater than 1.0 can be collected within the pocket portion. The at least one overflow port allows the received storm water to continue flowing through the drain as the storm water exceeds the volume capacity of the pocket portion.

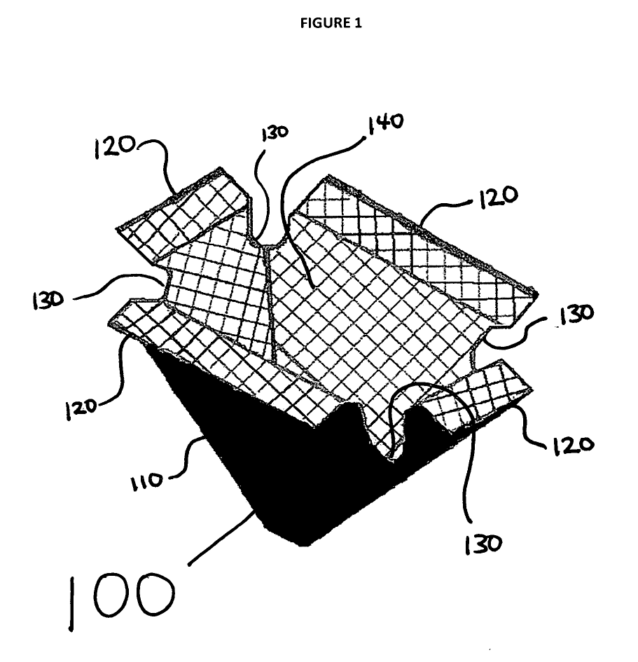

FIG. 1 illustrates exemplary embodiment of the present invention, in which a storm water filtration device 100 can include a pocket portion 110, at least one engagement element 120, at least one overflow port 130, and an optional inner liner 140.

As described, and as apparent from, this disclosure, the present invention can be utilized in conjunction with plural storm drain configurations.

In an exemplary aspect of the present invention, pocket portion 110 can be formed from an at least substantially impermeable material, such that the material can allow the pocket portion to fill with storm water given a foreseeable flow rate of storm water. It should be noted, however, that the material can be completely impermeable if so desired.

In another exemplary aspect, pocket portion 110 can be provided in any shape that provides a cavity for receiving storm water, whether symmetric or asymmetric; and in any size that can fit within a storm drain to which the present invention is applied. Thus, pocket portion 110 can be any shape or size that is functionally compatible with the particular environment in which the invention is applied, and expressly, is not limited to the specific shape and/or size illustratively described herein.

In yet another exemplary aspect, given a particular size and shape, pocket portion 110 can have a particular volume capacity, which will also be defined by the one or more overflow ports 130 discussed infra.

In still another exemplary aspect, optionally, pocket portion 110 can further include inner liner 140 disposed within the pocket portion. Inner liner 140 can be formed of a porous material that can capture and retain at least a part of a liquid contaminant and/or a solid contaminant carried by the storm water entering pocket portion 110, as the storm water flows against and/or through the inner liner. Inner liner 140 can be provided in any size or shape that can fit within pocket portion and can functionally capture and retain at least a part of either or both types of contaminant. Notably, inner liner 140 need not touch or cover the entire inner surface area of pocket portion 110. For example and not in limitation, inner liner 140 can be shaped similarly to and/or differently from; and/or sized smaller than, larger than, or equally to, pocket portion 110; shaped, housed, sized and/or configured in the same, different, or similar manner as any known, apparent, or future developed filter medium, such as an oil or air filter for example and not in limitation; or provided in any symmetric or asymmetric shape and/or size functionally compatible with the present invention. In yet still another exemplary aspect, inner liner 110 can be removable or removably attachable to the inside of pocket portion 110, in whole or in part, which can allow advantageous replacement thereof.

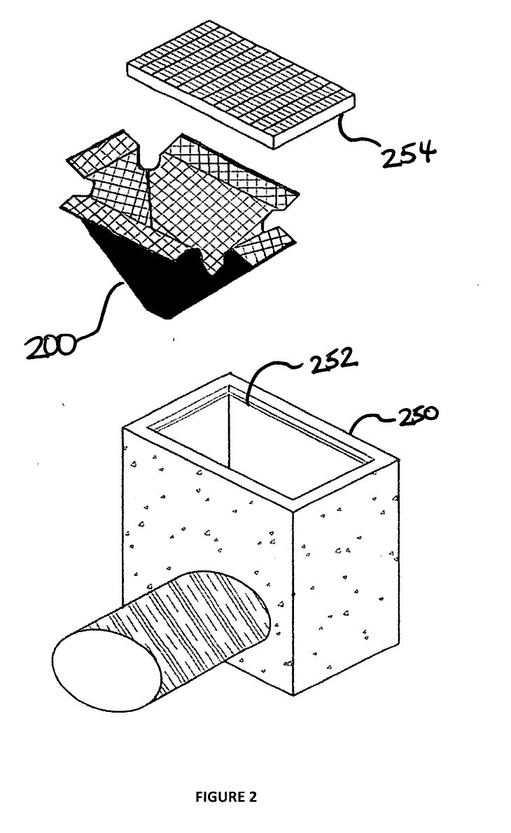

FIG. 2 illustrates an exploded view of an exemplary environment of the present invention, in which storm water filtration device 200 can be utilized with a storm drain 250 having an opening 252 and a storm grate 254.

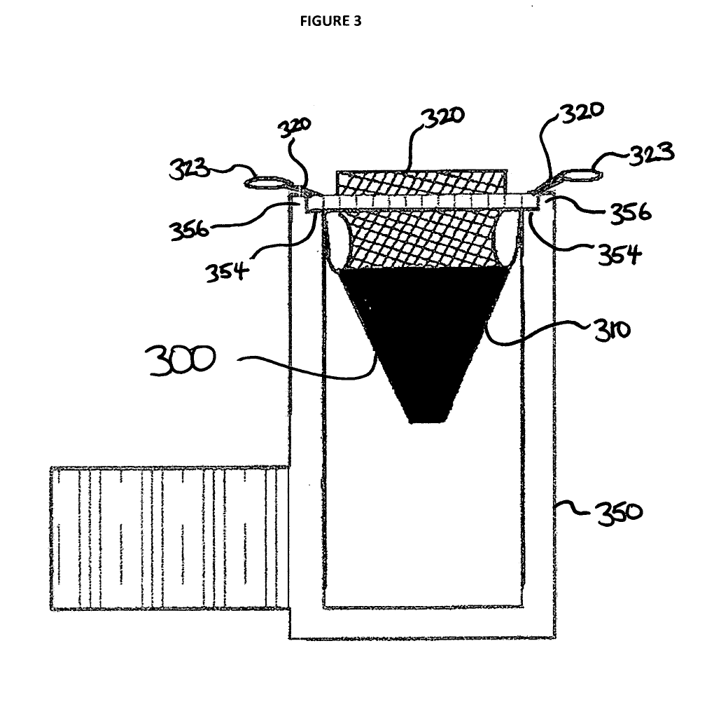

FIG. 3 illustrates an exemplary application of an exemplary storm water filtration device 300, in which an engagement element 320 can be adapted to engage storm drain 350 by being held between a part 356 of the storm drain and a storm grate 354. Notably, engagement element 320 can engage any portion of storm drain 350, either directly or indirectly (by attachment, connection, etc. to any other structure fixed or otherwise engaged with a storm drain); and thus, can be provided in any functionally compatible manner desired. Operationally, storm water (not shown) can enter storm drain 350 through storm grate 354, and then enter pocket portion 310. Notably, where storm drain 350 includes an alternative or additional opening (not shown) through which storm water enters the drain, storm grate 354 can be a drain cover.

In another exemplary aspect of the present invention, engagement element 320 can extend from pocket portion 310, and can be adapted to engage storm drain 350 so as to fixably position the pocket portion within the storm drain.

In a further exemplary aspect of the present invention, to accommodate various storm drain environments, engagement element 320 can be provided in a plurality of structures.

In one example, as illustrated in FIG. 3, engagement element 320 can be a part of pocket portion 310, illustrated as flaps extending from the pocket portion; and alternatively or conjunctively, can be any terminal edge or other part of the pocket portion (not shown).

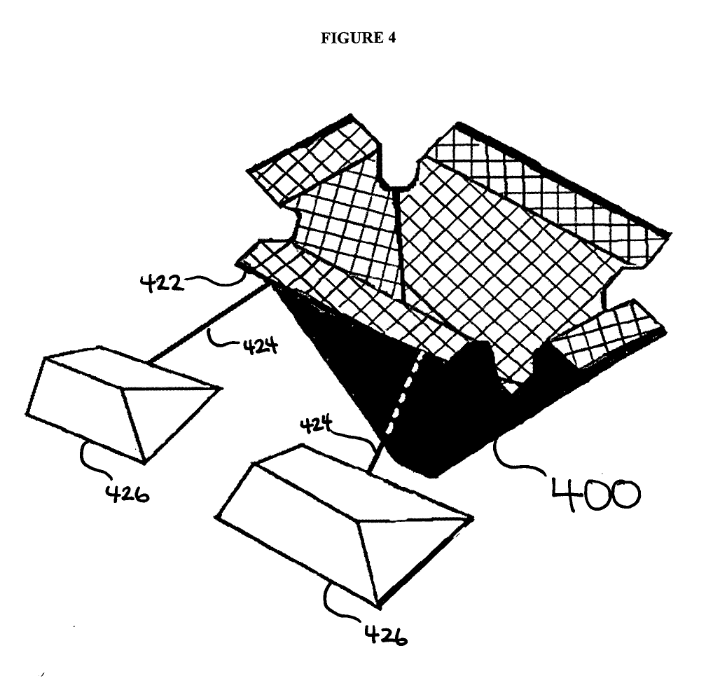

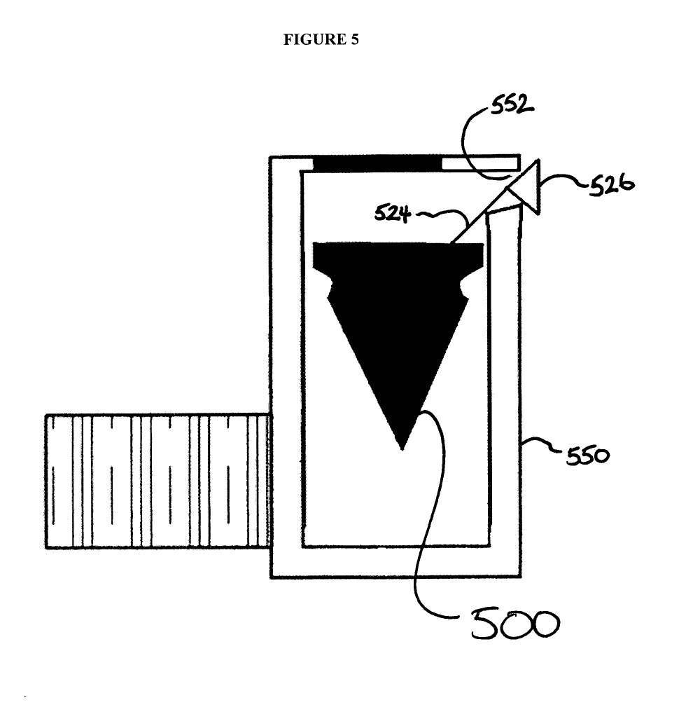

In another example, as illustrated in FIG. 4, an engagement element can be a flap 422 having an extension element 424 with an abutment element 426. FIG. 5 illustrates an exemplary application of the filtration device 400 of FIG. 4, in which an extension element 524 can be adapted to extend through an opening 552 of storm drain 550 and connect the filtration device 500 to abutment element 526, while the abutment element abuts part of drain 550, which provides a secure engagement with the drain.

It should be noted that additional exemplary aspects (not shown) can include an engagement element 520 directly connected to an abutment element 526; and an engagement element 520 as an extension element 524 directly connecting an abutment element 526 to a pocket portion 510.

As illustrated in FIG. 5, abutment element 526 can have an overall size greater than an opening 552 of drain 550 along one axis of the opening, such that an abutment function can be effectuated. Thus, abutment element 526 can be provided in any shape and/or size that provide an abutment function, and is expressly not limited to any specific shape and/or size illustratively shown herein.

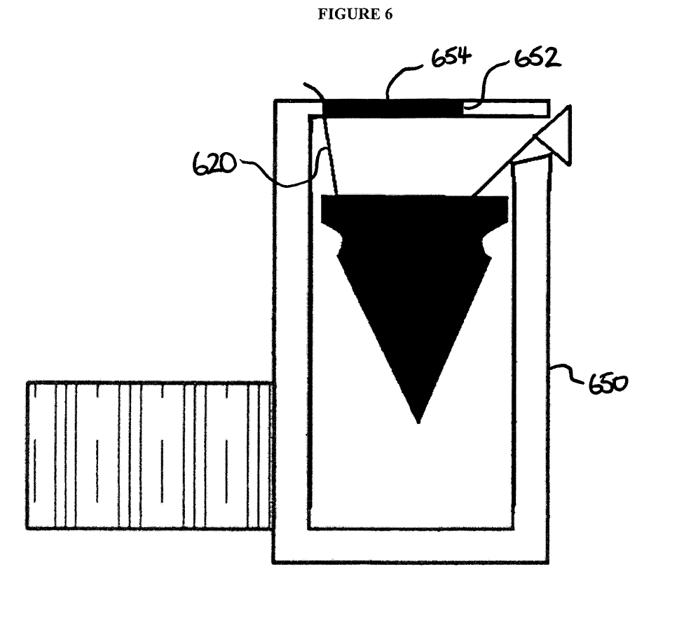

FIG. 6 illustrates a storm water filtration device 600 similar to that illustrated in FIG. 5, but with an, additional or alternative, engagement element 620 engaged with storm drain 650 by being held between part of the storm drain defining a drain opening 652 and at least one of a storm grate 654 and a drain cover (not shown).

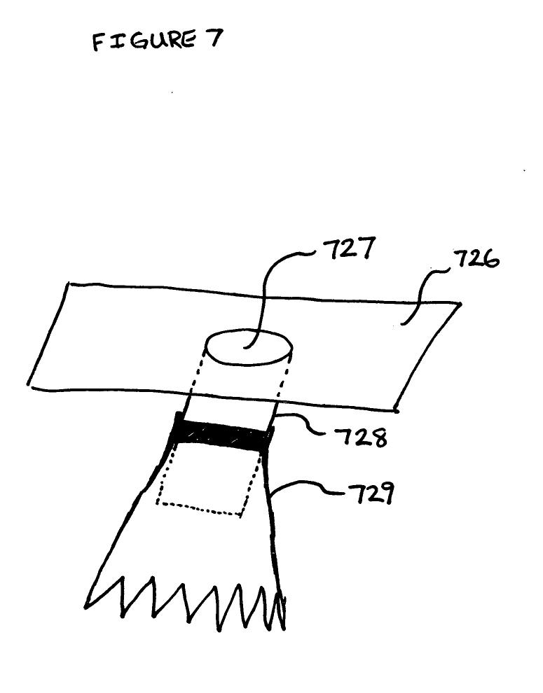

FIG. 7 illustrates yet another exemplary aspect of the present invention, where an engagement element 720 of device 700 can include, an abutment element 726 having an input aperture 727 and an exhaust flange 728, and an intake sleeve 729 adapted to connect to the exhaust flange.

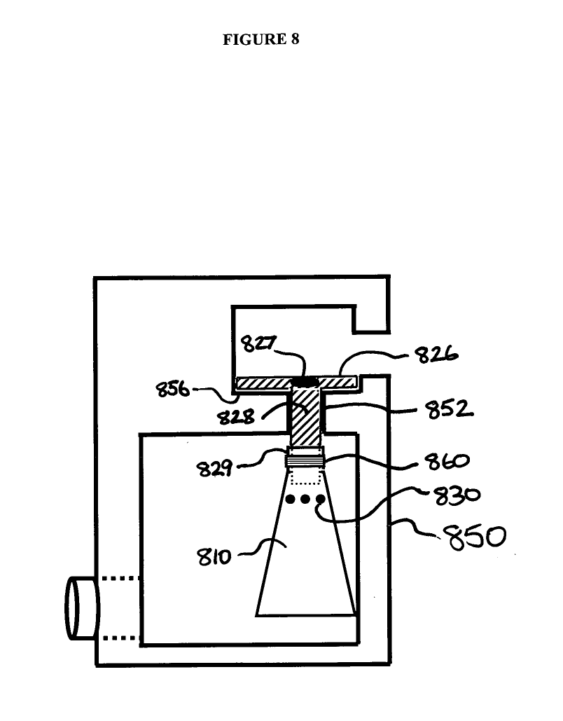

FIG. 8 illustrates an exemplary application of the filtration device 700 of FIG. 7, in which abutment element 826 can have an overall size greater than a storm drain opening 852 along one or more axes of the opening so as to allow its abutment with part 856 of storm drain 850. As further illustrated, abutment element 826 can be positioned such that exhaust flange 828 passes through opening 852 of storm drain 850 with input aperture 827 being positioned in alignment with the opening. With abutment element 826 so positioned, intake sleeve 829 can be connected to exhaust flange 828, such that in operation, storm water entering storm drain 850 can enter input aperture 827, exhaust through exhaust flange 828, and be received into pocket portion 810 via intake sleeve 829. It should be noted that any type of compatible connection structure can be utilized to connect intake sleeve 829 to exhaust flange 828. For example, where exhaust flange 828 includes a cylindrical shape, intake sleeve can be disposed around the exhaust flange and clamped there against via a clamp 860, such as a hose clamp, zip-tie, or any other clamping structure desired that will securely connect intake sleeve 829 to exhaust flange 828.

In still yet a further exemplary aspect of the present invention, an overflow port can be defined at least in part by the impermeable material. For example and not in limitation, as illustrated in FIG. 1, overflow port 130 can be formed, at least in part, from an upper terminal portion of the impermeable material of pocket portion 110. Alternatively, as illustrated in FIG. 8, an overflow port 830 can be an aperture within the impermeable material.

It should be noted that in conjunction with the size and shape of the pocket portion, one or more overflow ports define a volume capacity of the pocket portion, which can define the maximum capacity of storm water a pocket portion can hold before the storm water flows through the one or more overflow ports.

In a further exemplary aspect of the present invention, a method of installing a storm water filtration device can include positioning the pocket portion within a storm drain, and engaging the at least one engagement element with the storm drain so as to fixably position the pocket portion within the storm drain. Accordingly, as storm water enters the storm drain, at least a portion is directed into the pocket portion for contaminant removal; and the at least one engagement element fixes the pocket portion's position(s) to ensure that at least a portion of the storm water enters the pocket portion.

In another exemplary aspect of the present invention, a method of maintaining a storm water filtration device can include accessing the pocket portion; and removing at least a portion of the contaminants collected within the pocket portion.

In a further exemplary aspect of the present invention, accessing the pocket portion can include removing the filtration device from the storm drain, which can be advantageous with pocket portions having greater depths. Thus, an engagement element can optionally include a lifting element, which can be any structure that facilitates lifting, which by hand or machine, of a storm water filtration device. For example, a lifting element can be a handle, a grip, or a pole loop, for example and not in limitation. For example, as illustrated in FIG. 3, a lifting element 323 can be a pole loop, through which a pole can be inserted to facilitate the lifting of any embodiment of storm water filtration device 300. Notably, a lifting element can also be utilized to facilitate installation of the present invention by providing a temporary fixation thereof whilst engagement is effectuated. For example and not in limitation, a handle, grip, or pole loop can be fixed to some structure, or held in place manually or via a pole having a length greater than an opening of the drain along an axis of the opening.

However, it should be noted that removal of the pocket portion is not necessarily required or even desirable in some cases, as contaminants could be readily removed by hand, vacuum, net, with or without extensions (e.g., an extension pole or functionally equivalent element), etc. Additionally, to the extent desirable, accessing the pocket portion can include removing a storm grate or a drain cover; but notably, this is not necessarily required, as access could be via a drain opening without a grate or cover.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention. For example, the present invention need not be oriented in an absolute upright position, as a drain opening can introduce water at various angles. Thus, the present invention can be adapted to accommodate a wide range of angles at which storm water is provided to a storm drain. Further, the present invention can be attached directly to a pipe and/or utilized in conjunction with any pre-existing filtration system. Moreover, particular exemplary features described herein in conjunction with specific embodiments and/or aspects of the present invention are to be construed as applicable to any embodiment described within, enabled hereby, or apparent herefrom. Thus, the specification and drawings are to be regarded in a broad, illustrative, and enabling, rather than a restrictive, sense.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A storm water filtration device for removing contaminants carried by storm water entering a storm drain, said device comprising:
a pocket portion, being formed of an at least substantially impermeable material, and having a volume capacity;
at least one engagement element extending from said pocket portion, and being adapted to securely engage the storm drain so as to fixably position said pocket portion within the storm drain; and
at least one overflow port, defined at least in part by the material;
wherein when said at least one engagement element is engaged with the storm drain, said pocket portion is positioned to receive at least a portion of the storm water entering the storm drain, such that at least a portion of the contaminants, carried by the storm water, and having a specific gravity greater than 1.0, are collected within said pocket portion, while said at least one overflow port allows the received storm water to continue flowing through the drain as the received storm water exceeds the volume capacity of said pocket portion.

2. The storm water filtration device of claim 1,
wherein said pocket part includes an inner liner disposed within said pocket portion, and formed of a porous material adapted to capture and retain at least a portion of one of a liquid contaminant carried by the storm water and a solid contaminant carried by the storm water.

3. The storm water filtration device of claim 1, wherein said at least one engagement element comprises an extension element including an abutment element having an overall size greater than an opening of the drain along one axis of the opening, and the extension element is adapted to extend through the opening while the abutment element abuts a portion of the drain so as to securely engage the storm drain.

4. The storm water filtration device of claim 3, wherein the abutment element is integral with the extension element.

5. The storm water filtration device of claim 3, wherein the abutment element is attached to the extension element.

6. The storm water filtration device of claim 1, wherein said at least one engagement element comprises a plurality of extension elements, each extension element having a respective abutment element being sized greater than an opening of the drain along one axis of the opening, and the extension elements being adapted to extend through the opening while the respective abutment elements abut one or more portions of the drain so as to securely engage the storm drain.

7. The storm water filtration device of claim 6, wherein the respective abutment elements are integral with the respective extension elements.

8. The storm water filtration device of claim 6, wherein the respective abutment elements are attached to the respective extension elements.

9. The storm water filtration device of claim 1, wherein said at least one engagement element comprises, an abutment element having an input aperture and an exhaust flange, and an intake sleeve adapted to connect to, and receive the at least a portion of the storm water from, the exhaust flange; the abutment element having an overall size greater than an opening of the drain along at least one axis of the opening; and the abutment element is adapted, to abut a portion of the storm drain so as to securely engage the storm drain, to receive via the aperture the at least a portion of the storm water, and to direct the at least a portion of the storm water through the exhaust flange.

10. The storm water filtration device of claim 1, wherein said at least one engagement element includes at least one lifting element.

11. The storm water filtration device of claim 10, wherein said at least one lifting element is a handle.

12. The storm water filtration device of claim 10, wherein said at least one lifting element is pole loop.

13. The storm water filtration device of claim 1, wherein said at least one engagement element is adapted to engage the storm drain by being held between a part of the storm drain and a storm grate engaged with an opening of the storm drain.

14. The storm water filtration device of claim 1, wherein said at least one engagement element is adapted to engage the storm drain by being held between a part of the storm drain and a drain cover engaged with an opening of the storm drain.

15. A method of installing the storm water filtration device of claim 1, comprising:
positioning said pocket portion within the storm drain; and
engaging said at least one engagement element with the storm drain so as to fixably position said pocket portion within the storm drain.

16. A method of maintaining the storm water filtration device of claim 1, comprising:
accessing said pocket portion; and
removing the at least a portion of the contaminants collected within said pocket portion.

17. The method of claim 16, wherein accessing said pocket portion includes removing the filtration device from the storm drain.

18. The method of claim 16, wherein accessing said pocket portion includes removing one of a storm grate and a drain cover of the storm drain.

19. The method of claim 16, further comprising replacing an inner liner of said pocket portion.
